(19) United States
(12) Patent Application Publication
(10) Pub. No.: US 2024/0141101 A1
(43) Pub. Date: May 2, 2024

(54) POLYESTERAMINES AND POLYESTER QUATS

(71) Applicant: ARKEMA FRANCE, COLOMBES (FR)

(72) Inventors: Henry DELROISSE, Pierre-Benite (FR); Gilles BARRETO, Pierre-Benite (FR); Eric JORDA, Columbes (FR); Alain BALOCHE, Saint-Laurent Blangy (FR)

(21) Appl. No.: 18/275,318

(22) PCT Filed: Feb. 3, 2022
(86) PCT No.: PCT/FR2022/050203

§ 371 Date: Aug. 1, 2023

(30) Foreign Application Priority Data
Feb. 4, 2021 (FR) 2101067

(51) Int. Cl. C08G 63/685

(52) U.S. Cl. CPC C08G 63/685

(57) ABSTRACT

The present invention relates to compounds obtainable by esterification condensation of: A/ at least one alkoxylated fatty amine of formula (I), or of the product of partial or complete quaternization of said alkoxylated fatty amine of formula (I): in which R¹, AO, B, n, m, s and y are as defined in the description, B/ with at least one dicarboxylic acid, or a derivative thereof, of formula (II) as follows: in which D and R_{A} are as defined in the description, C/ with at least one (alkyl)alkanolamine derivative of formula (III) or of the product of partial or complete quaternization of said (alkyl)alkanolamine derivative of formula (III) as follows: in which A″O, u, u′ and R⁷ are as defined in the description, and D/ with at least one fatty acid of formula (V) as follows: in which R¹¹ is as defined in the description. The invention further relates to the use of said compound as a surfactant, biocide, corrosion inhibitor or wetting agent in the fields of hygiene, cosmetics, detergents, human and animal health, agrochemicals, the textile industry, the mining industry, the fertilizer industry, the bitumen industry, road construction, road maintenance, sealing, the water treatment industry, and more generally the chemical, petroleum and gas industries.

The present invention relates to compounds with structures of polyesteramines and quaternized polyesteramines, referred to as “polyester quats”. These new compounds may be used in a great many fields of application, and especially as surfactants and corrosion inhibitors, etc., to name only some of the applications possible.

Fatty alkylamines and derivatives of them in quaternary ammonium form are chemical substances which are particularly useful and are widely employed nowadays in a great variety of industries, whether this be for example in the fields of hygiene, cosmetics, detergents, human and animal health, agrochemicals, the textile industry, the mining industry, the fertilizer industry, the bitumen industry, road construction, road maintenance, sealing, the water treatment industry, and more generally the chemical, petroleum and gas industries.

Although many alkylamines and their quaternary ammonium derivatives are indeed already known and in use, there is nevertheless actively continuing research into new, even more effective molecules, with improved properties. In the course of the last 20 years, for example, another family of nitrogen-containing compounds of higher molecular weight has emerged in the literature. These compounds have a polymeric or oligomeric structure and comprise amine and quaternary ammonium functions.

International application WO 2008/089906 describes a product of reaction of a fatty acid with a diacid and an (alkyl)polyethanolamine, said reaction product then being quaternized and used as a collector for the flotation of certain types of ore. Similarly, international application WO 2011/147855 describes quaternary ammonium compounds originating from the reaction of a fatty alcohol with a diacid and an (alkyl)polyethanolamine, which are used for the flotation of silicates.

More recently still, international applications WO 2012/028542, WO 2013/038192 and WO 2014/095797 describe various polyesteramines and polyester quats that can be used as corrosion inhibitors or flotation agents or as depressants.

Notwithstanding, there is still a need for new cationic oligomeric or polymeric compounds for uses in the fields of application set out above, these new compounds being more easily preparable, more stable, less expensive to synthesize and also having better environmental properties in terms of toxicity and biodegradability, and having improved technical performance qualities.

The inventors have now uncovered a new family of polyesteramines and polyester quats that is to be described in detail in the rest of the present specification. Absent indication to the contrary, all ranges of values that are presented hereinafter are understood as having their endpoints included.

Consequently, and according to a first aspect, the present invention relates to a compound obtainable by esterification condensation of: A/ an alkoxylated fatty amine of formula (I), or the product of partial or total quaternization of said alkoxylated fatty amine of formula (I):

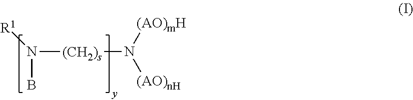

in which:
R¹ is chosen from a hydrocarbyl radical having from 8 to 24 carbon atoms, preferably 10 to 24 and more preferably 12 to 24 carbon atoms, and a radical of formula R⁴—O-(A′O)_{w}-T—, in which R⁴ is a hydrocarbyl radical having from 8 to 24 carbon atoms, preferably 10 to 24 and more preferably 12 to 24 carbon atoms, w represents an integer of between 0 and 20, preferably between 0 and 10, more preferably between 0 and 6 and even more preferably between 0 and 4, A′O is an alkylenoxy radical containing 2 to 4 carbon atoms, preferably 2 or 3 carbon atoms, more preferably 2 carbon atoms, and T represents an alkylene radical containing from 1 to 6 carbon atoms, preferably 1 to 4 carbon atoms and most preferably with 2 or 3 carbon atoms,
AO is an alkylenoxy radical containing from 2 to 4 carbon atoms, preferably with 2 or 3 carbon atoms, more preferably with 2 carbon atoms,
B is chosen from a C₁-C₄ alkyl radical, an aryl radical, an arylalkyl radical, and a radical (AO)_{m′}H,
n, m and m′, which are identical or different, represent each independently of one another an integer between 1 and 20, preferably between 1 and 10, more preferably between 1 and 6 and even more preferably between 1 and 4,
s represents 1, 2 or 3, preferably 2 or 3, and
y is an integer ranging from 0 to 5, preferably from 0 to 3, more preferably y is 0 or 1, even more preferably y is 0,
   B/ with at least one dicarboxylic acid, or a derivative thereof, of formula (II):

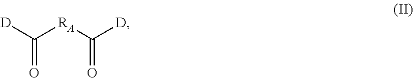

wherein
D is chosen from —F, —Cl, —Br and —O—R³, in which R³ is chosen from hydrogen and a C₁-C₄ alkyl radical,
R_{A} is chosen from the group consisting of:
a direct bond,
a linear or branched, saturated or unsaturated C₁-C₂₀ hydrocarbon chain optionally substituted by one or more —OH radicals, preferably an alkylene radical of formula —(CH₂)₂—, in which z is an integer from 1 to 20, preferably from 1 to 10, preferably from 2 to 6 and most preferably 2 to 4, an alkylene radical being substituted by 1 or 2 —OH radicals, an alkenylene radical having from 1 to 20 and preferably from 1 to 10 carbon atoms, and optionally substituted by 1 or 2 methyl and/or methylene radicals,
a cycloalkylene radical,
a cycloalkenylene radical, and
an arylene radical,
   C/ with at least one (alkyl)alkanolamine derivative of formula (III) or of the product of partial or total quaternization of said (alkyl)alkanolamine derivative of formula (III):

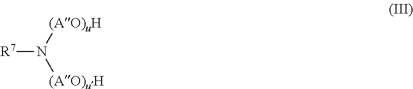

in which:
A″O represents an alkylenoxy radical containing from 2 to 4 carbon atoms, preferably 2 or 3 carbon atoms, more preferably 2 carbon atoms,
u represents an integer between 1 and 20, preferably between 1 and 10, more preferably between 1 and 6, and even more preferably between 1 and 4,
u′ represents an integer between 1 and 20, preferably between 1 and 10, more preferably between 1 and 6, and even more preferably between 1 and 4,
R⁷ is chosen from a hydrocarbyl radical having from 1 to 7, preferably 1 to 6 carbon atoms, more preferably 1 to 4 carbon atoms, an aryl or arylalkyl radical, a radical of formula H—(OA″)ᵥ— (in which v represents an integer between 1 and 20, preferably between 1 and 10, more preferably between 1 and 6, and even more preferably between 1 and 4), a radical HO(CH₂)_{q}—, in which q represents an integer from 1 to 10, preferably from 2 to 6, and most preferably q is 2 or 3, and a radical of formula (IV) as follows:

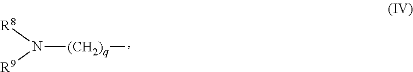

in which R⁸ and R⁹, which are identical or different, are chosen from a hydrocarbyl radical containing from 1 to 6 carbon atoms, preferably 1 to 4 carbon atoms, and q is an integer from 1 to 10, preferably from 2 to 6, and most preferably q is 2 or 3,
or else R⁸ and R⁹, together with the nitrogen atom to which they are attached, form a 5-, 6- or 7-membered ring, optionally including one or more heteroatoms chosen from oxygen, nitrogen and sulfur, and
   D/ with at least one fatty acid of formula (V) as follows:

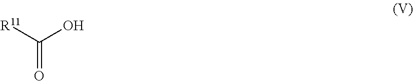

in which R¹¹ is chosen from a hydrocarbyl radical containing from 8 to 24 carbon atoms, preferably 10 to 24, more preferably 12 to 24 carbon atoms, and a radical of formula R⁴—O-(A′O)_{w}-T—, in which A′, R⁴, T and w are as defined before.

In the present description, “hydrocarbyl” denotes a linear or branched, saturated or unsaturated hydrocarbyl chain, i.e., a linear or branched hydrocarbon chain which is saturated or may contain one or more double bonds and/or triple bonds and/or rings. The term “aryl” denotes for example phenyl or naphthyl, and the term “phenylalkyl” denotes for example benzyl.

In one preferred embodiment, the compound according to the present invention is obtained by esterification condensation as defined above, in which, in the fatty amine of formula (I), R¹ includes 8 or more than 8 carbon atoms, typically from 8 to 24 carbon atoms, preferably from 10 to 24, more preferably from 12 to 24 carbon atoms, and in the (alkyl)alkanolamine derivative of formula (III), R⁷ includes 6 carbon atoms or less, typically from 1 to 6 carbon atoms, more preferably 1 to 4 carbon atoms, limits included.

In an even more preferred embodiment, the compound according to the present invention is obtained by esterification condensation as defined above, in which, in the fatty amine of formula (I) and in the (alkyl)alkanolamine derivative of formula (III), R¹ and R⁷ are such that the difference in the number of carbon atoms they include is greater than 2, typically from 2 to 23, preferably 5 to 23, more preferably 10 to 23, limits included.

It is understood that the dicarboxylic acids or derivatives thereof of formula (II) also comprise the corresponding anhydride forms thereof. It is also understood that when the alkylenoxy chain contains more than one alkylenoxy radical, the alkylenoxy radicals may be identical or different. Similarly, when y is greater than 1 (one), the repeating units may be identical or different.

The present invention also relates to the compound of the present invention (which may be obtained by reaction between the alkoxylated fatty amine of formula (I), the dicarboxylic acid or a derivative thereof of formula (II), the (alkyl)alkanolamine derivative of formula (III) and the fatty acid of formula (V)), the compound obtained after additional reaction in which one or more of the nitrogen atoms are quaternized by reaction with a reactant of formula R⁵X, in which R⁵ is chosen from a C₁-C₆ hydrocarbyl radical, preferably a C₁-C₄ alkyl, aryl and arylalkyl, radical, and X is any leaving group known to the skilled person, and preferably X is generally chosen from halogens, sulfates, carbonates, sulfonates, etc.

Formula (1) below is one possible representation of the compounds of the present invention, as described above, which may be obtained by the esterification condensation of the alkoxylated fatty amine of formula (I) (comprising its partial or total quaternization product), with the dicarboxylic acid, or a derivative thereof, of formula (II), with an (alkyl)alkanolamine derivative of formula (III) (comprising its partial or total quaternization product), and with the fatty acid of formula (V).

Consequently, and according to a second aspect, the present invention relates to a compound of general formula (1):

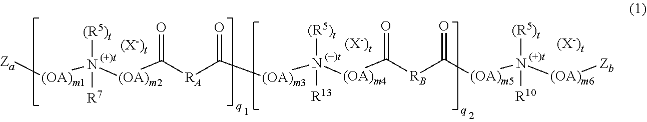

in which:
R⁵ and X are as defined above,
t represents 0 or 1, with the proviso that the indices “t”, independently of one another, which are present in the formula may be identical or different,
Zₐ and Z_{b}, which are identical or different, are each chosen from a hydrogen atom, a radical —(C=O)—R_{A}—(C=O)OH, a radical —(C=O)—R_{B}—(C=O)OH and a radical —(C=O)R¹¹, in which R¹¹ is as defined above, with the condition that at least one of the two groups Zₐ and Z_{b} is a radical —(C=O)R¹¹,
R_{A} and R_{B}, which are identical or different, are chosen independently of one another from:
   a direct bond,
   a linear or branched, saturated or unsaturated C₁-C₂₀ hydrocarbon chain optionally substituted by one or more —OH radicals, preferably an alkylene radical of formula —(CH₂)₂—, in which z is an integer from 1 to 20, preferably from 1 to 10, preferably from 2 to 6 and most preferably 4, a substituted alkylene radical, said alkylene radical being substituted by 1 or 2 —OH radicals, an alkenylene radical having from 1 to 20 and preferably from 1 to 10 carbon atoms, a substituted alkenylene radical, said alkenylene radical being substituted by 1 or 2 methyl and/or methenyl radicals,
   a cycloalkylene radical,
   a cycloalkenylene radical, and
   an arylene radical.
q₁ and q₂, which are identical or different, each represent an integer between 0 and 15, preferably between 0 and 10, more preferably between 0 and 5, with the proviso that:
   the sum q₁+q₂ is other than 0, and
   when q₁ is zero, R¹⁰ and R⁷ are identical, and
   when q₂ is zero, R¹⁰ and R¹³ are identical, and
   the repeating units present q₁ times and q₂ times may be arranged at random, in alternation, statistically, sequentially or in blocks,
OA represents an alkylenoxy radical containing from 2 to 4 carbon atoms, preferably 2 or 3 carbon atoms, more preferably 2 carbon atoms, on condition that all the radicals OA present in the compound of formula (1) are each independently of one another identical or different,
m₁, m₂, m₃, m₄, m₅ and m₆, which are identical or different, independently of one another each represent an integer between 1 and 20, preferably between 1 and 10, more preferably between 1 and 6, and more preferably still between 1 and 5,
each radical R¹³, independently of one another, represents R¹ or a radical R¹²—(G)_{y}—,
R¹⁰ represents R¹³ or R⁷,
R⁷ is chosen from a hydrocarbyl radical having from 1 to 7, preferably 1 to 6 carbon atoms, more preferably 1 to 4 carbon atoms, an aryl or arylalkyl radical (for example, a phenyl or naphthyl group), a radical of formula H—(OA″)ᵥ— (in which v represents an integer between 1 and 20, preferably between 1 and 10, more preferably between 1 and 6, and even more preferably between 1 and 4, limits included), HO(CH₂)_{q}—, in which q represents an integer from 1 to 10, preferably from 2 to 6, and most preferably q is 2 or 3, and a radical of formula (2):

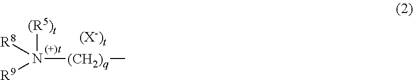

in which R⁵, X and t are as defined above, and Fe and R 9 , which are identical or different, are chosen from a hydrocarbyl radical having 1 to 6 carbon atoms, preferably 1 to 4 carbon atoms, and q is an integer from 1 to 10, preferably from 2 to 6, limits included, and most preferably q is 2 or 3, or else R⁸ and R⁹, together with the nitrogen atom to which they are attached, form a 5-, 6- or 7-membered ring, including optionally one or more heteroatoms chosen from oxygen, nitrogen and sulfur,
R¹² is chosen from a hydrocarbyl radical having 8 to 24 carbon atoms, preferably 10 to 24, more preferably 12 to 24 carbon atoms, and a radical of formula R⁴—O-(A′O)_{w}-T—, in which R⁴ is a hydrocarbyl radical having 8 to 24 carbon atoms, preferably 12 to 24 carbon atoms, w represents an integer between 0 and 20, preferably between 0 and 10, more preferably between 0 and 6 and even more preferably between 0 and 4, A′O represents an alkylenoxy radical containing 2 to 4 carbon atoms, preferably 2 or 3 carbon atoms, more preferably 2 carbon atoms, and T represents an alkylene radical containing from 1 to 6 carbon atoms, preferably 1 to 4 carbon atoms and most preferably 2 or 3 carbon atoms,
R¹ is as defined above,
G represents a radical of formula (3):

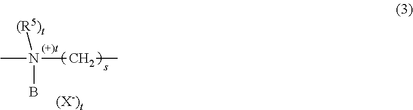

in which:
R⁵, X and t are as defined above,
B is chosen from C₁-C₄ alkyl, aryl and arylalkyl radicals, and
s represents 1, 2 or 3, preferably 2 or 3, with the proviso that if there are two or more variables with the same name present in the compound of formula (1), they may be identical or different, independently of one another.

In one particular embodiment, the alkoxylated fatty amine of formula (I) is the alkoxylated fatty amine of formula (IA):

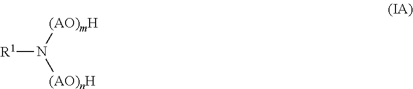

which is the alkoxylated fatty amine of formula (I) in which y represents O and R¹, AO, m and n are as defined above,
and also the corresponding partially or totally quaternized derivatives thereof.

In another particular embodiment, the (alkyl)alkanolamine derivative of formula (III) is the (alkyl)alkanolamine derivative of formula (IIIA):

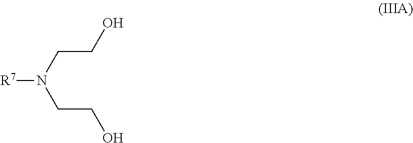

which is the (alkyl)alkanolamine of formula (III) in which u and u′ each represent 1, A″O is ethylenoxy and R⁷ is as defined above. In the compound of formula (IIIA) above, R⁷ is preferably a hydrocarbyl radical having 1 to 4 carbon atoms. The compound of formula (IIIA) above also covers the corresponding partially or totally quaternized derivatives thereof.

The dicarboxylic acid derivative of general formula (II) described above may be any dicarboxylic acid or dicarboxylic acid derivative or anhydride that is known to the skilled person. Typically, the dicarboxylic acid derivative of formula (II) may be a dicarboxylic acid, a dicarboxylic acid halide, for example a chloride, a dicarboxylic acid diester, or a cyclic anhydride of a dicarboxylic acid. The most suitable derivatives of formula (II) in the context of the present invention are dicarboxylic acids and the corresponding cyclic anhydrides thereof.

Illustrative examples of dicarboxylic acid derivatives of formula (II) comprise oxalic acid, malonic acid, succinic acid, glutaric acid, glutaconic acid, adipic acid, muconic acid, pimelic acid, phthalic acid and isomers thereof, tetrahydrophthalic acid, malic acid, maleic acid, fumaric acid, suberic acid, mesaconic acid, sebacic acid, azelaic acid, tartaric acid, itaconic acid, glutinic acid, citraconic acid, brassylic acid, dodecanedioic acid, traumatic acid, thapsic acid, the corresponding acid chlorides thereof, the corresponding methyl or ethyl esters thereof, and the corresponding cyclic anhydrides thereof, phthalic anhydride, and also mixtures thereof.

According to one especially preferred embodiment of the present invention, the especially suitable dicarboxylic acid derivatives of formula (II) are chosen from oxalic acid, malonic acid, succinic acid, glutaric acid, adipic acid, pimelic acid, phthalic acid and isomers thereof, tetrahydrophthalic acid, malic acid, tartaric acid, itaconic acid, the corresponding acid chlorides thereof, the corresponding methyl or ethyl esters thereof, and the corresponding cyclic anhydrides thereof, phthalic anhydride, and also mixtures thereof.

The alkoxylated fatty amines of formula (I) defined above are either directly available commercially or may be prepared according to any process known in the literature, and may be readily prepared, for example, by alkoxylation of fatty amines of formula (a):

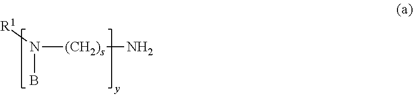

in which R¹, B, s and y are as defined above.

Illustrative examples of fatty amines of formula (a) above that are especially suitable for use as starting materials for the preparation of alkoxylated fatty amines of formula (I) comprise, but are not limited to, the fatty amines of formula (a1) in which y represents 0 and the fatty amines of formula (a2) in which y represents 1, s represents 3 and B represents methyl:

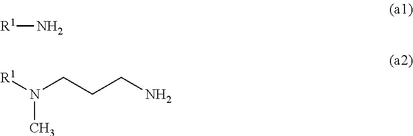

formulae (a1) and (a2) in which R¹ is as defined above.

Particular examples of amines of formula (a1) are the amines for which R¹ represents a radical of formula R⁴—O-(A′O)_{w}-T—, and conform to the formula (a3) as follows:

R⁴—O-T-NH₂ (a3),

in which R⁴ and T are as defined above and w is 0.

More specific examples of the amines of formulae (a1), (a2) and (a3) mentioned above include, but are not limited to, 2-ethylhexylamine, 2-octylamine, 2-propylheptylamine, n-octylamine, n-decylamine, n-dodecylamine, n-tetradecylamine, n-hexadecylamine, n-octadecylamine, oleylamine, erucylamine, N-(n-decyl)-N-methyl-trimethylenediamine, N-(n-dodecyl)-N-methyl-trimethylenediamine, N-erucyl-N-methyltrimethylenediamine, isotridecyl-poly(propoxy)amine, 2-octyl-poly(propoxy)amine, amines produced from fatty acids originating from plant oils or animal fats, such as colza oil, sunflower oil, soybean oil, coconut oil, copra oil, palm oil, tall oil, tallow, etc., and particularly N-(coconut)-N-methyltrimethylenediamine, N-(colza)-N-methyl-trimethylenediamine, N-(soybean)-N-methyl-trimethylenediamine, N-(tallow)-N-methyl-trimethylenediamine, N-(hydrogenated tallow)-N-methyl-trimethylenediamine, etc., and also mixtures of two or more thereof, in any proportions.

According to one embodiment of the invention, the amines mentioned above are fatty amines obtained from natural acids or oil (plant or animal) and mixtures thereof, for example coconut fatty acids, tallow fatty acids, colza oils, sunflower oils, soybean oils and palm oils.

These fatty amines are then typically alkoxylated with 2 to 40, preferably 2 to 20, more preferably 2 to 12 and even more preferably 2 to 8 EO (ethylene oxide units), and/or 2 to 40, preferably 2 to 20, more preferably 2 to 12 and even more preferably 2 to 8 PO (propylene oxide units), and/or 2 to 40, preferably 2 to 20, more preferably 2 to 12 and even more preferably 2 to 8 BO (butylene oxide units). Blocks with EO are generally added first and PO and/or BO last, or blocks with PO and/or BO added first and EO last, or successions of more than two blocks are added, or mixtures of EO and PO and/or BO, to produce randomly alkoxylated products of general formula (I). The alkoxylation may be performed via any suitable process known in the art using, for example, an alkaline catalyst, such as potassium hydroxide (KOH), or an acid catalyst, double-metal catalysis (DMC catalysis), or even without catalyst.

As indicated above, some compounds of formula (I) are available commercially and include, without limitation, Noramox® SD20, Noramox® SD15, Noramox® S11, Noramox® S5, Noramox® S7, Noramox® S2, Noramox® SH2, Noramox® O2, Noramox® O5, Noramox® C2, Noramox® C5, and Noramox® C15, all of which are available from Arkema. Other examples of products of formula (I) comprise, in particular, Tomamine® E-17-5 and Tomamine® E-T-2, which are sold by Air Products.

(Alkyl)alkanolamine derivatives of formula (III) are available or may be prepared according to any process described in the literature. Illustrative examples of suitable (alkyl)alkanolamine derivatives of formula (III) comprise, but are not limited to, triethanolamine, methyldiethanolamine, ethyldiethanolamine, propyldiethanolamine, butyldiethanolamine, isobutyldiethanolamine, pentyldiethanolamine, phenyldiethanolamine, hexyldiethanolamine, heptyldiethanolamine, and also the corresponding alkoxylation products thereof.

Other examples of amines that are suitable as starting materials for the preparation of alkoxylated derivatives of formula (III) comprise, without limitation, methylamine, ethylamine, propylamines, butylamines, pentylamines, hexylamines, heptylamines, dimethylaminoethylamine, diethylaminoethylamine, dimethylaminopropylamine (DMAPA), diethylaminopropylamine (DEAPA), dipropylaminopropylamine, dibutylaminopropylamine (DBAPA), 1-(3-aminopropyl)-2-pyrrolidine, 3-morpholinopropylamine, 1-(3-aminopropyl)piperidine and 1-(3-aminopropyl)pipecoline.

The fatty acids of formula (V) defined above are available or are prepared according to procedures which are known or are readily adapted from procedures which are known in the scientific literature, in the patent literature or on the Internet. Illustrative examples of suitable fatty acids of formula (V) in the context of the present invention comprise, but are not limited to, capric acid, caprylic acid, palmitic acid, stearic acid, oleic acid, linoleic acid, myristoleic acid, palmitoleic acid, linoleic acid, octanoic acid, nonanoic acid, decanoic acid, undecanoic acid, dodecanoic acid, and octodecanoic acid.

As already set out above, an entirely suitable process for preparing the products for use in the present invention comprises a first step of mixing at least one compound of formula (I) with at least one compound of formula (II), at least one compound of formula (III) and at least one compound of formula (V), all as defined above, and then a second step of performing an esterification condensation reaction between the compounds in the mixture.

Yet other processes enable access to the compounds useful in the context of the present invention, including, for example, processes in which the compounds of formulae (I), (II), (III) and (V) react sequentially one after another, or in groups, in any order, according to the chemical reactions taking place, under operating conditions well-known to the skilled person.

It is thus possible, for example, to perform an esterification condensation reaction between compounds of formulae (I), (II) and (III) in a first stage, and then to perform another esterification condensation reaction of this condensation product with a compound of formula (V) in a subsequent step.

More generally, the compounds of formula (1) of the present invention may be prepared from esterification condensation reaction(s) in which at least one compound of formula (I) and at least one compound of formula (II) and at least one compound of formula (III) and at least one compound of formula (V) react in one or more simultaneous and/or sequential and/or alternating esterification condensation reactions.

The esterification condensation reaction which takes place between the compounds of formula (II) and of formulae (I) and (III) is a reaction that is known per se in the prior art. The reaction is preferably performed in the presence of an esterification catalyst, such as a base, for example a Brønsted base, or such as an acid, for example a Brønsted acid or a Lewis acid, for example methanesulfonic acid, para-toluenesulfonic acid, hypophosphoric acid, citric acid or boron trifluoride (BF₃).

When a dicarboxylic acid derivative of formula (II) in which D is O—R³ is used, the reaction is a transesterification, which, as a variant, may be performed in the presence of an alkaline catalyst. In yet further variants, other conventional techniques known to the skilled person may be used, starting from other dicarboxylic acid derivatives, for example starting from the anhydrides thereof or the acid chlorides thereof.

As will be apparent to the skilled person, the various esterification reactions may be performed with or without addition of solvents. If solvents are added and present during the reaction, they are generally and advantageously inert toward the esterification reaction. Non-limiting examples of solvents that can be used for these esterification reactions include toluene, xylene, etc.

The esterification condensation reactions between the components (I), (II), (III) and (V) are generally performed under conditions well-known to the skilled person and may for example be performed at a temperature typically within the range from 60° C. to 300° C., preferably from 120° C. to 280° C., and for a time generally within the range from 1 hour to several hours, preferably from 2 hours to 20 hours. The esterification condensation reactions are generally performed at atmospheric pressure, though it is also possible to operate under reduced pressure, or under pressure, for example at pressures of between 500 Pa and 20 000 Pa.

The respective ratios of the compounds of formulae (I), (II), (III) and (V) may vary within wide proportions according to the end compound(s) desired and the operating conditions employed. As an example, and without imposing any limiting restriction on the invention, one specific embodiment of the present invention employs a molar ratio between the compounds of formula (II) and the compounds of formula (V) on the other side of generally between 5:1 and 1:5, preferably between 3:1 and 1:3, and more preferably between 3:1 and 1:1. In another specific embodiment of the present invention, the molar ratio between the compounds of formulae (I) and (V) is between 6:1 and 1:6, preferably between 5:1 and 1:5, and more preferably between 4:1 and 1:4.

In another specific embodiment of the present invention, the molar ratio between the compounds of formulae [(I)+(III)] and the compounds of formula (II) is between 6:1 and 1:6, preferably between 2:1 and 1:1, and more preferably between 3:2 and 5:4. According to a further embodiment, the molar ratio between the compounds of formulae (I) and (III) is between 15:1 and 1:15, preferably between 10:1 and 1:10, more preferably between 4:1 and 1:4, more preferably still between 3:1 and 1:3.

When a quaternary product is desired, the preparation process advantageously also comprises at least one step consisting in adding an alkylating agent to the condensation product and a step of performing said quaternization reaction on the condensation product, according to techniques well-known to the skilled person.

Accordingly, when all of the indices tin the compound of formula (1) are 0, said compound of formula (1) is a tertiary polyesteramine compound. When all of the indices tin the compound of formula (1) are 1, the compound of formula (1) is completely quaternized and is a quaternary polyester polyammonium compound, resulting from the quaternization of the entirety of the nitrogen atoms present in the compound of formula (1) in which the indices t are 0. As a variant, when only some of the indices t are 0 and the other indices t are 1, the compound of formula (1) is a partially quaternized polyesteramine compound.

As indicated above, the quaternization reaction step may be carried out according to any method well-known to the skilled person, generally and most often by means of at least one alkylating agent. Preferred alkylating agents for the quaternization reaction, partial or complete, may thus be chosen advantageously from compounds of formula R⁵X, where R⁵ and X are as defined above. Illustrative examples of such alkylating agents, without intending any limitation whatsoever, include methyl chloride, methyl bromide, methyl iodide, dimethyl sulfate, diethyl sulfate, dimethyl carbonate and benzyl chloride. According to one especially preferred aspect, the alkylating agents are chosen from methyl chloride, dimethyl sulfate, diethyl sulfate and benzyl chloride, and also mixtures thereof, more preferably from methyl chloride, dimethyl sulfate and mixtures thereof.

According to a further embodiment, the quaternization reaction may be carried out on the fatty amine of formula (I) and/or on the (alkyl)alkanolamine derivative of formula (III) prior to performance of the esterification condensation reaction(s) with the dicarboxylic acid or a derivative thereof of formula (II). According to yet further embodiments, the quaternization reaction may be carried out on the intermediate compounds obtained during the sequential or alternating esterification condensation reactions. One or more complete or partial quaternization reactions may be performed after any one of these intermediate steps.

The quaternization reactions are generally performed in water and/or in one or more organic solvents, such as ethanol, isopropanol (IPA), ethylene glycol monobutyl ether, di(ethylene glycol) monobutyl ether (BDG), monoethylene glycol (MEG), diethylene glycol (DEG), or mixtures thereof. The preferred solvents are chosen from isopropanol (IPA), ethanol, and mixtures thereof in any proportions.

The quaternization reaction temperature may vary within wide proportions and is generally in the range from 20° C. to 120° C., preferably at least 40° C., more preferably at least 50° C., and most preferably at least 55° C., and preferably not more than 90° C. The quaternization reaction is typically performed for a time within the range from several tens of minutes to several tens of hours, preferably from one hour to 100 hours, more preferably within a range between 1 hour and 30 hours.

As already indicated, the quaternization reaction may be partial or complete. The progress of the quaternization reaction may be monitored by any means well-known to the skilled person, and for example by monitoring the reduction in the total alkalinity of the reaction mixture. “Complete quaternization” is obtained when the total alkalinity value is generally less than or equal to 0.2 meq/g, preferably less than or equal to 0.1 meq/g, more preferably less than or equal to 0.05 meq/g, as measured by titration with hydrochloric acid.

According to one embodiment, the preferred compounds of formula (1) are those in which one or more, or all, of the following propositions are respected:
R_{A} and R_{B} are chosen from the group consisting of divalent hydrocarbyl radicals having from 1 to 10, preferably from 2 to 6 and most preferably 4 carbon atoms,
R⁷ is chosen from a hydrocarbyl radical having 1 to 4 carbon atoms, preferably 1 to 2 carbon atoms and most preferably R⁷ represents methyl,
OA represents an ethoxy radical and
m₁, m₂, m₃, m₄, m₅, m₆, q, q₂, t and R⁵ are as defined above.

According to another embodiment, preferred compounds of formula (1) are those in which all of the indices “t” are equal to 1, i.e., all the nitrogen atoms are quaternized (which signifies “complete quaternization”), all the other variable radicals and integers being as defined above.

According to a further embodiment, preferred compounds of formula (1) are those in which all the indices “t” are equal to 1 and R⁵ is chosen from methyl and ethyl, all the other variable radicals and integers being as defined above.

According to another, additional embodiment, preferred compounds of formula (1) are those in which all the indices “t” are equal to 1, R⁵ is chosen from methyl and ethyl, and X is chosen from halogens and sulfates (for example, methosulfate), all the other variable radicals and integers being as defined above.

In another embodiment, preferred compounds of formula (1) are those in which all of the indices “t” are equal to 0, i.e., all the nitrogen atoms are not quaternized, all the other variable radicals and integers being as defined above.

According to a further embodiment, preferred compounds of formula (1) are those in which all the indices “t” are equal to 0 and R⁵ is chosen from methyl and ethyl, all the other variable radicals and integers being as defined above.

According to another, additional embodiment, preferred compounds of formula (1) are those in which all the indices “t” are equal to 0, R⁵ is chosen from methyl and ethyl, and X is chosen from halogens and sulfates (for example, methosulfate), all the other variable radicals and integers being as defined above.

According to another embodiment, preferred compounds of formula (1) are those in which each m₁, m₂, m₃, m₄, m₅ and m₆, independently of one another, are identical or different, and are chosen from 1, 2, 3, 4, 5 and 6, and all the other variable groups and integers are as defined above.

According to another preferred embodiment of the present invention, the compounds of formula (1) are those obtained by simultaneous/sequential/alternating esterification condensation reaction(s) of:
at least one compound of formula (I) in which y=0 and R¹ is chosen from a hydrocarbyl radical having 8 to 24 carbon atoms, preferably 10 to 24 and more preferably 12 to 24 carbon atoms, and AO, m and n are as defined above,
at least one compound of formula (II),
at least one compound of formula (III) in which R 7 is a hydrocarbyl radical having 1 to 7 and preferably 1 to 6 carbon atoms, more preferably 1 to 4 carbon atoms, and A″O, u and u′ are as defined above, and
at least one compound of formula (V), and also the products of partial or complete quaternization reaction thereof.

According to one very particularly preferred embodiment of the invention, the preferred compounds of formula (1) are those obtained by simultaneous/sequential/alternating esterification condensation reaction(s) of:
at least one compound of formula (I) in which y=0 and R¹ is chosen from a hydrocarbyl radical having 8 to 24 carbon atoms, preferably 10 to 24 and more preferably 12 to 24 carbon atoms, AO is ethoxy, and m and n are as defined above,
at least one compound of formula (II), and
at least one compound of formula (III) in which R⁷ is a hydrocarbyl radical having 1 to 7 and preferably 1 to 6 carbon atoms, more preferably 1 to 4 carbon atoms, A″O represents ethoxy, and u and u′ are as defined above, and
at least one compound of formula (V), and also the products of partial or complete quaternization reaction thereof.

According to one very particularly preferred aspect, the compounds of formula (1) of the invention are those obtained by simultaneous/sequential/alternating esterification condensation reaction(s) of:
at least one compound of formula (I) in which y=0 and R¹ represents a hydrocarbyl radical having from 8 to 24 carbon atoms, preferably 10 to 24 and more preferably 12 to 24 carbon atoms, AO is ethoxy, and m and n, each independently of one another, and identical or different, represent an integer between 1 and 10, preferably between 1 and 6, more preferably between 1 and 5, limits included,
at least one compound of formula (II), chosen from diacids (D represents —OH) and the corresponding anhydrides thereof, in which R A is a divalent hydrocarbyl radical having from 1 to 14, more preferably from 1 to 10 and even more preferably from 1 to 8 carbon atoms, and
at least one compound of formula (III) in which R⁷ is a hydrocarbyl group having from 1 to 7, preferably 1 to 6 carbon atoms and more preferably from 1 to 4 carbon atoms, A″O is ethoxy, and u and u′ each represent 1, and
at least one compound of formula (V) in which R¹¹ is chosen from a hydrocarbyl radical having from 8 to 24 carbon atoms, preferably 10 to 24 and more preferably 12 to 24 carbon atoms and 0 or 1 to 4 double bonds,
   and also the products of complete quaternization reaction thereof with methyl chloride.

Typically, preferred compounds of formula (1) are those obtained by simultaneous/sequential/alternating esterification condensation reaction(s) of:
at least one compound of formula (I) chosen from n-octylamine, n-decylamine, n-dodecylamine, (coconut-alkyl)amine, (palm oil-alkyl)amine, n-tetradecylamine, n-hexadecylamine, n-octadecylamine, oleylamine, (tallow-alkyl)amine, (hydrogenated tallow-alkyl)amine, (colza-alkyl)amine, (soybean-alkyl)amine, erucylamine, alkoxylated with 2 to 20, preferably 2 to 10 EO (ethylene oxide units), and/or 2 to 20, preferably 2 to 10 PO (propylene oxide units),
at least one compound of formula (II) chosen from malonic acid, succinic acid, glutaric acid, glutaconic acid, adipic acid, muconic acid, pimelic acid, phthalic acid and isomers thereof, tetrahydrophthalic acid, malic acid, maleic acid, fumaric acid, suberic acid, mesaconic acid, sebacic acid, azelaic acid, tartaric acid, itaconic acid, glutinic acid, citraconic acid, brassylic acid, dodecanedioic acid, traumatic acid, thapsic acid, the corresponding acid chlorides thereof, the corresponding methyl or ethyl esters thereof, and the corresponding cyclic anhydrides thereof, and also mixtures thereof, and
at least one compound of formula (III) chosen from methyldiethanolamine, ethyldiethanolamine, propyldiethanolamine, butyldiethanolamine, isobutyldiethanolamine, pentyldiethanolamine, hexyldiethanolamine, heptyldiethanolamine, and also the corresponding alkoxylation products thereof, and
at least one compound of formula (V), which may for example and without limitation be chosen from caproic acid, caprylic acid, lauric acid, myristic acid, palmitic acid, stearic acid, oleic acid, linoleic acid, linolenic acid, and mixtures thereof,
   and also the products of partial or complete quaternization reaction thereof.

The most preferred compounds of formula (1) according to the present invention are those obtained by simultaneous/sequential/alternating esterification condensation reaction(s) of:
at least one compound of formula (I) chosen from n-dodecylamine, amines produced from fatty acids originating from plant oils or animal fats, such as colza oil, sunflower oil, soybean oil, coconut oil, copra oil, palm oil, tall oil, tallow, etc., and particularly N-(coconut)-N-methyltrimethylenediamine, N-(colza)-N-methyl-trimethylenediamine, N-(soybean)-N-methyl-trimethylenediamine, N-(tallow)-N-methyl-trimethylenediamine, N-(hydrogenated tallow)-N-methyl-trimethylenediamine, and erucylamine, these amines being alkoxylated with from 2 to 20, preferably 2 to 10 EO (ethylene oxide units),
at least one compound of formula (II) chosen from malonic acid, succinic acid, glutaric acid, glutaconic acid, adipic acid, muconic acid, pimelic acid, phthalic acid and isomers thereof, tetrahydrophthalic acid, malic acid, maleic acid, fumaric acid, suberic acid, mesaconic acid, sebacic acid, azelaic acid, tartaric acid, itaconic acid, glutinic acid, citraconic acid, brassylic acid, dodecanedioic acid, traumatic acid, thapsic acid, the corresponding acid chlorides thereof, the corresponding methyl or ethyl esters thereof, and the corresponding cyclic anhydrides thereof, and also mixtures thereof, and
at least one compound of formula (III) chosen from methyldiethanolamine, ethyldiethanolamine, propyldiethanolamine, butyldiethanolamine, isobutyldiethanolamine, pentyldiethanolamine, hexyldiethanolamine, heptyldiethanolamine, and also the corresponding ethoxylation products thereof, and
at least one compound of formula (V), which may for example and without limitation be chosen from caproic acid, caprylic acid, lauric acid, myristic acid, palmitic acid, stearic acid, oleic acid, linoleic acid, linolenic acid, and mixtures thereof,
   and also the products of partial or complete quaternization reaction thereof.

More preferably, the compounds of formula (1) according to the present invention are those obtained by simultaneous/sequential/alternating esterification condensation reaction(s) of:
at least one compound of formula (I) chosen from n-dodecylamine, amines produced from fatty acids originating from plant oils or animal fats, such as colza oil, sunflower oil, soybean oil, coconut oil, copra oil, palm oil, tall oil, tallow, etc., and particularly N-(coconut)-N-methyltrimethylenediamine, N-(colza)-N-methyl-trimethylenediamine, N-(soybean)-N-methyl-trimethylenediamine, N-(tallow)-N-methyl-trimethylenediamine, N-(hydrogenated tallow)-N-methyl-trimethylenediamine, and erucylamine, these amines being alkoxylated with from 2 to 20, preferably 2 to 10 EO (ethylene oxide units),
at least one compound of formula (II) chosen from malonic acid, succinic acid, glutaric acid, adipic acid, pimelic acid, maleic acid, fumaric acid, suberic acid, sebacic acid, azelaic acid, brassylic acid, dodecanedioic acid, the corresponding cyclic anhydrides thereof, and
at least one compound of formula (III) chosen from methyldiethanolamine, ethyldiethanolamine, propyldiethanolamine, butyldiethanolamine, isobutyldiethanolamine, pentyldiethanolamine, hexyldiethanolamine, heptyldiethanolamine,
at least one compound of formula (V),
   and also the products of complete quaternization reaction thereof with methyl chloride.

The compounds of formula (1) according to the invention have many advantages, and among these advantages mention may be made of their preparation process, which is relatively easy to perform, even on an industrial scale. The majority of the compounds of formula (1), indeed, may be readily prepared from inexpensive and readily available starting materials.

The compounds which are obtainable conventionally and readily for example from at least one compound of formula (I) (comprising the product of partial or complete quaternization thereof) by esterification condensation with at least one alkoxylated fatty amine of formula (I), with at least one dicarboxylic acid or a derivative thereof, of formula (II), and with at least one (alkyl)alkanolamine derivative of formula (III) (comprising the product of partial or complete quaternization thereof), and also with at least one fatty acid of formula (V), and especially the compound of formula (1) as defined above and according to the present invention, possess numerous advantageous properties.

As such, these compounds may be used in a great many fields of application and in particular, by way purely of illustration and without any wish to impose any restriction at all, as surfactants, biocides, corrosion inhibitors and wetting agents, etc.

More particularly, the compounds according to the present invention may in particular be used in any type of industries in the fields of hygiene, cosmetics, detergents, human and animal health, agrochemicals, the textile industry, the mining industry, the fertilizer industry, the bitumen industry, road construction, road maintenance, sealing, the water treatment industry, and more generally the chemical, petroleum and gas industries.

Among all of the possible applications, mention may be made of uses in biocidal, or biostatic, compositions, and of uses thereof in the mining, petroleum and gas industries, in the plant health products industry, especially for fertilizers, but also in the detergents and cleaning industries and in cosmetics.

More specifically, these compounds, as such, obtained by esterification condensation of at least one alkoxylated fatty amine of formula (I) (comprising the product of partial or complete quaternization thereof), with at least one dicarboxylic acid or a derivative thereof, of formula (II), with at least one (alkyl)alkanolamine derivative of formula (III) (comprising the product of partial or complete quaternization thereof), and with at least one fatty acid of formula (V), and more particularly the compound of formula (1) as defined above, generally and usually possess strong properties of adsorption on mineral or metal surfaces or other solid particles, but also, by virtue of their viscosity-enhancing or more generally rheology control, emulsifying or stabilizing or complexing properties, they may be useful for the chemical industry as a general rule and particularly for the industry associated with gas and petroleum extraction and recovery.

In this vein, accordingly, they can be used as wetting agents, anticaking agents, as collectors for ore enrichment by direct or indirect flotation (with non-limiting examples including the enrichment of carbonates, phosphates, potash, feldspar, quartz, iron), as corrosion inhibitors, in the field for example of petroleum and gas production, as viscosity enhancers, emulsifiers or stabilizers or complexing agents for the petroleum and gas industry, for example as demulsifiers, anti-asphaltene agents, as antiagglomerants and/or kinetic inhibitors for hydrates, especially gas hydrates, as agents to counter mineral deposits, as surfactants to enhance petroleum recovery, surfactants for enhanced oil recovery, surfactants for fracturing fluids, surfactants for acidification fluids, surfactants for improving production and/or saltwater injectivity, surfactants for improving production water quality, surfactants for drilling muds, and others.

The aforesaid compounds of the present invention may also be used as acid attack additives for phosphate rock, fertilizer additives and additives for surface or internal treatment of inorganic salts, clay modifiers, dispersants, lubrication additives or adhesion promoters, and in the bitumen industry, as an additive for bitumen, for example for the manufacture of bitumen emulsions, as bitumen emulsion additives.

Yet further uses are possible in the detergents and cleaning industries, and in cosmetics, particularly as additives in haircare products, as tissue and fabric softeners, as antistatic agents in polymers, or additives intervening in crosslinking for plastics, as cationic detergents, for example in the industrial detergents field, car-washing, as hydrotrope agents, as wetting agents, as fertilizer additives, as lubrication or metalworking additives, as a fuel additive, as a biocide, as adhesion promoters, as a water treatment additive, as an acid attack additive for phosphate rocks, as a dispersant additive, as a rheology control additive, and others.

The invention will become more clearly apparent by means of the following examples, which are presented solely for illustrative purposes, without any intention of limiting the scope of the desired protection defined by the appended claims. As indicated earlier, throughout the description, examples and claims, all the ranges of values should be understood as being “limits included” (that is to say that the limits are included in said ranges), unless specifically indicated otherwise.

### MEASUREMENT METHODS

### Process For Measuring Acid Number

Throughout the examples which follow, the acid number is measured by potentiometric titration using a potassium hydroxide solution as reagent and isopropyl alcohol as solvent.

About 10 g of sample to be analyzed are accurately weighed out (Sw in g, accuracy to within one mg) in a 250 ml beaker and 70 ml of isopropyl alcohol are added. The mixture is stirred and heated gently, if necessary, to obtain a homogeneous sample. The combined reference glass electrode of the titrator is introduced into the solution, which is then stirred with a magnetic stirrer. Acid-base titration of the sample is performed using aqueous 0.1 N potassium hydroxide (KOH) solution and the change in pH is recorded on the titrator. The equivalence point is determined by graph using processes known to the skilled person, and the volume (V_{KOH}, in ml) of potassium hydroxide solution used to reach this point is determined. The acid number (AV) is then obtained according to the following calculation:

$$AV = \frac{[ Normalité de la solution de KOH ( mol / L ) ] \times 56 , 1 \times {V}_{KOH}}{Sw}$$

### Process For Measuring Total Alkalinity

Throughout the examples which follow, the total alkalinity value is measured by potentiometric titration using a hydrochloric acid solution as reagent and isopropyl alcohol as solvent.

About 3 g of sample to be analyzed are accurately weighed out (accuracy to within one mg, Sw in g) in a 100 ml polypropylene beaker and 60 ml of isopropyl alcohol are added. The mixture is stirred and heated gently, if necessary, to obtain a homogeneous sample. Once the temperature of the solution has returned to room temperature, the combined reference glass electrode of the titrator is introduced into the solution, which is then stirred with a magnetic stirrer. The sample is titrated using a 0.2 N hydrochloric acid (HCl) solution of accurately known normality (N, in m_{eq.}ml⁻¹), and the change in pH is recorded on the titrator. The equivalence point is determined using processes known to the skilled person, and the volume (V_{HCl}, in ml) of hydrochloric acid solution used to reach this point is determined. The total alkalinity value (Alk), expressed in meq g⁻¹, is then obtained according to the following calculation:

$$Alk = \frac{{V}_{HCl} * N}{Sw}$$

### EXAMPLE 1: SYNTHESIS OF PRODUCT A (ACCORDING TO THE INVENTION)

715.6 g (4 mol) of ethoxylated (2 EO) tallow-amine supplied by Arkema under the trade name Noramox® S2, 476.0 g (4 mol) of methyldiethanolamine (purity>99%) supplied by Taminco and 0.58 g of aqueous hypophosphorous acid solution at 50% by weight are introduced into a 4 I round-bottom flask. The mixture is heated to 80° C. with nitrogen sparging. The bubbling with nitrogen is maintained throughout the test duration. At temperature, 584.6 g (4 mol) of adipic acid are then introduced with stirring. After 15 minutes, the temperature of the mixture is heated to reach 190° C. at a rate of 30° C./hour. The temperature of 190° C. is maintained until virtually all of the acid is consumed, or until the acid number reached is lower strictly than 5. Still at the temperature of 190° C., 1100 g (4 mol) of tallow fatty acid are added in 1 hour. The mixture is maintained at 190° C. for 6 hours, then at 200° C. for 4 hours, and then lastly is cooled to recover 2616.11 g (weight at end of reaction) of a crude liquid product with an orangey/brown color that contains the expected esteramine, the unreacted amines, unreacted diacid and unreacted fatty acid.

### EXAMPLE 2: SYNTHESIS OF PRODUCTS B TO K (ACCORDING TO THE INVENTION)

According to the same process as in example 1, the following products were prepared from the compounds indicated in table 1 below:

TABLE 1
Compounds and amounts used for the synthesis of compounds B to K

| Ethoxylated | | | | | | | | |
|---|---|---|---|---|---|---|---|---|
| fatty | Mass | Dicarboxylic | Mass | (Alkyl)alkanolamine | Mass | Fatty acid | Mass | |
| amine of | of (I) | acid of | of (II) | derivative of | of (III) | derivative | of (V) | |
| formula (I) | (in g) | formula (II) | (in g) | formula (III) | (in g) | of [symbol] | (in g) | Product |
| NoxS2 | 715.6 | Ad. ac. | 876.8 | MDEA | 714.0 | TFA | 550.0 | B |
| NoxS2 | 715.6 | Ad. ac. | 878.8 | MDEA | 714.0 | TFA | 1100.0 | C |
| NoxS2 | 536.7 | Ad. ac. | 878.8 | MDEA | 714.0 | TFA | 825.0 | D |
| NoxS2 | 715.6 | Ad. ac. | 584.6 | MDEA | 476.0 | TFA | 349.8 | E |
| NoxS2 | 715.7 | Ad. ac. | 584.6 | MDEA | 476.0 | TFA | 708.3 | F |
| NoxS2 | 715.7 | Ad. ac. | 584.6 | MDEA | 476.0 | TFA | 975.2 | G |
| NoxS2 | 715.6 | Ad. ac. | 584.9 | MDEA | 476.0 | TFA | 766.3 | H |
| NoxS5 | 779.7 | Ad. ac. | 701.9 | MDEA | 571.2 | TFA | 880.0 | I |
| NoxS5 | 923.7 | Ad. ac. | 833.0 | MDEA | 678.3 | TFA | 522.7 | J |
| NoxS5 | 680.6 | Ad. ac. | 818.4 | 666.4 | 571.20 | TFA | 770.0 | K |

NoxS2 signifies ethoxylated (2 EO) tallow-amine supplied by Arkema under the trade name Noramox ® S2.
NoxS5 signifies ethoxylated (5 EO) tallow-amine supplied by Arkema under the trade name Noramox ® S5.
MDEA signifies methyldiethanolamine (purity level >99%) supplied by Taminco.
Ad. ac. signifies adipic acid.
TFA signifies tallow fatty acid. [symbol]
indicates data missing or illegible when filed

### EXAMPLE 3: SYNTHESIS OF A PRODUCT L (ACCORDING TO THE INVENTION)

1799.33 g of esteramine (product A) obtained in example 1 are introduced into a 6 I glass reactor with 170.1 g of isopropyl alcohol. The quaternization is carried out under a maximum pressure of 290 kPa in methyl chloride. The temperature is maintained between 80° C. and 85° C. until the reaction is complete, for 18 hours.

Reaction has been achieved when the total alkalinity is less than or equal to 0.2 meq.g⁻¹. The non-quaternized nitrogen content is then less than or equal to 2%. The reactor is subsequently cooled to 65° C. and the pressure returned to atmospheric pressure. Nitrogen is sparged into the mixture for 2 hours, after which 1909.0 g of crude, brown-colored reaction product L, still containing 6.6% by weight of isopropyl alcohol, are recovered.

### EXAMPLE 4: SYNTHESIS OF PRODUCTS M TO S (ACCORDING TO THE INVENTION)

Following the same procedure as in example 3, the products derived from quaternary chloromethylammonium were prepared from compounds E to K prepared in example 2, as indicated in table 2 below:

TABLE 2
Compounds and amounts used for the synthesis of compounds M to S

| | | | Mass of | Isopropanol | | | |
|---|---|---|---|---|---|---|---|
| | Mass of | Mass of | product | contained | | Reaction | Reaction |
| Product | product | isopropanol | obtained | in product | Quaternized | time | temperature |
| reacted | (g) | (g) | (g) | (% by m.) | product [symbol] | (h) | (° C.) |
| E | 1573.7 | 298.9 | 1756.8 | 7.4% | M | 16 | 73 |
| F | 1671.9 | 290.4 | 1796.4 | 7.9% | N | 14 | 80 |
| G | 1824.8 | 368.0 | 2170.2 | 12.6% | O | 12 | 78 |
| H | 1793.0 | 360.2 | 2067.3 | 6.52% | P | 12 | 80 |
| I | 1668.6 | 200.28 | 1904.76 | 7.6% | Q | 12 | 80 |
| J | 1816.5 | 225.7 | 1987.1 | 14.32% | R | 10 | 82 |
| K | 1811.1 | 251.5 | 2121.2 | 18.71% | S | 11 | 85 |

[symbol]

indicates data missing or illegible when filed

1-16. (canceled)

17. A compound obtained by esterification condensation of (A) with (B), (C), and (D):
(A) at least one alkoxylated fatty amine of formula (I), or the product of partial or total quaternization of said alkoxylated fatty amine of formula (I): 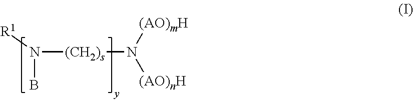
where:
R¹ is chosen from a hydrocarbyl radical having from 8 to 24 carbon atoms, or a radical of formula R⁴—O-(A′O)_{w}-T—, in which:
R⁴ is a hydrocarbyl radical having from 8 to 24 carbon atoms;
w represents an integer from 0 to 20;
A′O is an alkylenoxy radical containing 2 to 4 carbon atoms; and
T represents an alkylene radical containing from 1 to 6 carbon atoms;
AO is an alkylenoxy radical containing from 2 to 4 carbon atoms;
B is chosen from a C₁C₄ alkyl radical, an aryl radical, an arylalkyl radical, or a radical (AO)_{m′}H,
n, m, and m′, which are identical or different, represent each independently of one another an integer from 1 to 20;
s represents 1, 2, or 3; and
y is an integer from 0 to 5;
(B) at least one dicarboxylic acid, or a derivative thereof, of formula (II): 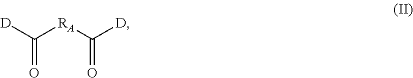
where:
D is chosen from —F, —Cl, —Br and —O—R³, in which R³ is chosen from hydrogen and a C₁-C₄ alkyl radical,
R_{A} is selected from the group consisting of:
a direct bond;
a linear or branched, saturated or unsaturated C₁-C₂₀ hydrocarbon chain optionally substituted by one or more —OH radicals, an alkylene radical of formula —(CH₂)_{z}— in which z is an integer from 1 to 20, an alkylene radical substituted by 1 or 2 —OH radicals, or an alkenylene radical having from 1 to 20 carbon atoms and optionally substituted by 1 or 2 methyl and/or methylene radicals;
a cycloalkylene radical;
a cycloalkenylene radical; and
an arylene radical;
(C) at least one (alkyl)alkanolamine derivative of formula (III) or of the product of partial or total quaternization of said (alkyl)alkanolamine derivative of formula (III): 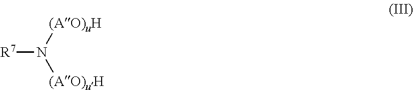
where:
A″O represents an alkylenoxy radical containing from 2 to 4 carbon atoms;
u represents an integer from 1 to 20;
u′ represents an integer from 1 to 20;
R⁷ is chosen from a hydrocarbyl radical having from 1 to 7, an aryl radical, and arylalkyl radical, a radical of formula H—(OA″)ᵥ— in which v represents an integer from 1 to 20, a radical HO(CH₂)_{q}—, in which q represents an integer from 1 to 10, or a radical of formula (IV): 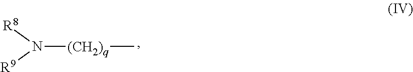
where either:
R⁸ and R⁹, which are identical or different, are chosen from a hydrocarbyl radical containing from 1 to 6 carbon atoms, and q is an integer from 1 to 10; or
R⁸ and R⁹, together with the nitrogen atom to which they are attached, form a 5-, 6- or 7-membered ring, optionally including one or more heteroatoms chosen from oxygen, nitrogen, and sulfur; and
(D) at least one fatty acid of formula (V) as follows: 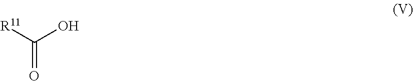
where:
R¹¹ is chosen from a hydrocarbyl radical containing from 8 to 24 carbon atoms or a radical of formula R⁴—O-(A′O)_{w}-T— in which:
R⁴ is a hydrocarbyl radical having from 8 to 24 carbon atoms;
w represents an integer from 0 to 20;
A′O is an alkylenoxy radical containing 2 to 4 carbon atoms; and
T represents an alkylene radical containing from 1 to 6 carbon atoms.

18. The compound as claimed in claim 17, wherein:
the radical R¹ of the fatty amine of formula (I) includes at least 8 carbon atoms; and
R⁷ in the (alkyl)alkanolamine derivative of formula (III) includes 6 or fewer carbon atoms.

19. The compound of claim 17, wherein the radical R¹ of the fatty amine of formula (I) and the radical R⁷ of the (alkyl)alkanolamine derivative of formula (III), are such that the difference in the number of carbon atoms they include is greater than 2.

20. The compound of claim 17, wherein some or all of the nitrogen atoms also react with a reactant of formula R⁵X, in which R⁵ is chosen from a C₁-C₆ hydrocarbyl radical, and X is a leaving group.

21. The compound of claim 17, wherein y is 0 in the alkoxylated fatty amine of formula (I), whereby the alkoxylated fatty amine of formula is an alkoxylated fatty amine of formula (IA) or a corresponding partially or totally quaternized derivative thereof: 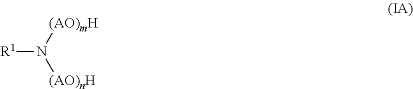
where R¹, AO, m, and n are as defined in formula (I).

22. The compound of claim 17, wherein u and u′ each represent 1 and A″O is ethylenoxy in the (alkyl)alkanolamine derivative of formula (III), whereby the (alkyl)alkanolamine derivative of formula (III) is an (alkyl)alkanolamine derivative of formula (IIIA) or a corresponding partially or totally quaternized derivative thereof: 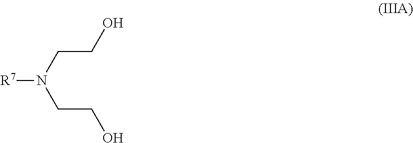
R⁷ is as defined in formula (III).

23. The compound of claim 17, wherein the dicarboxylic acid derivative of formula (II) is chosen from a dicarboxylic acid, a dicarboxylic acid halide, a dicarboxylic acid diester, or a cyclic anhydride of a dicarboxylic acid.

24. The compound of claim 17, wherein the dicarboxylic acid derivative of formula (II) is selected from oxalic acid, malonic acid, succinic acid, glutaric acid, glutaconic acid, adipic acid, muconic acid, pimelic acid, phthalic acid and isomers thereof, tetrahydrophthalic acid, malic acid, maleic acid, fumaric acid, suberic acid, mesaconic acid, sebacic acid, azelaic acid, tartaric acid, itaconic acid, glutinic acid, citraconic acid, brassylic acid, dodecanedioic acid, traumatic acid, thapsic acid, the corresponding acid chlorides thereof, the corresponding methyl or ethyl esters thereof, and the corresponding cyclic anhydrides thereof, phthalic anhydride, and also mixtures thereof.

25. The compound of claim 17, wherein the molar ratio of the compounds of formulas [(I)+(III)] to the compounds of formula (II) is from 6:1 to 1:6.

26. The compound of claim 17, wherein the molar ratio of the compounds of formula (I) to the compounds of formula (III) is from 15:1 to 1:15.

27. The compound of claim 17, wherein the molar ratio of the compounds of formula (I) to the compounds of formula (V) is from 6:1 to 1:6.

28. A compound obtained by the esterification condensation of claim 17 of (A) with (B), (C), and (D), corresponding to general formula (1): 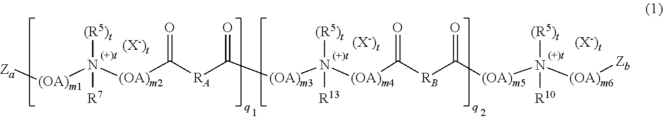
in which:
R⁵ is chosen from a C₁-C₆ hydrocarbyl radical, a C₁-C₄ alkyl, an aryl radical, or an arylalkyl radical;
X is chosen from halogens, sulfates, carbonates, or sulfonates;
t is 0 or 1, with the proviso that instances of tin formula (1), independently of one another may be identical or different;
Zₐ and Z_{b}, which are identical or different, are each chosen from a hydrogen atom, a radical —(C=O)—R_{A}—(C=O)OH, a radical —(C=O)—R_{B}—(C=O)OH, or a radical —(C=O)R¹¹, with the condition that at least one of the two groups Zₐ and Z_{b} is a radical —(C=O)R¹¹, where:
R¹¹ is chosen from a hydrocarbyl radical containing from 8 to 24 carbon atoms, or a radical of formula R⁴—O—(A′O)_{w}T—, in which:
R⁴ is a hydrocarbyl radical having 8 to 24 carbon atoms;
A′O represents an alkylenoxy radical containing 2 to 4 carbon atoms; and
T represents an alkylene radical containing from 1 to 6 carbon atoms;
w is an integer from 0 to 20; and
R_{A} and R_{B}, which are identical or different, are chosen independently of one another from:
a direct bond;
a linear or branched, saturated or unsaturated C₁-C₂₀ hydrocarbon chain optionally substituted by one or more —OH radicals;
an alkylene radical of formula —(CH₂)_{z}—, in which z is an integer from 1 to 20;
a substituted alkylene radical substituted by 1 or 2 —OH radicals;
an alkenylene radical having from 1 to 20 carbon atoms;
a substituted alkenylene radical substituted by 1 or 2 methyl and/or methenyl radicals;
a cycloalkylene radical;
a cycloalkenylene radical; or an arylene radical;
q₁ and q₂, which are identical or different, each represent an integer from 0 to 15, with the proviso that:
q₁+q₂ is not 0; and
when q₁ is zero, R¹⁰ and R⁷ are identical; and
when q₂ is zero, R¹⁰ and R¹³ are identical; and
the repeating units present q₁ times and q₂ times are arranged at random, in alternation, statistically, sequentially, or in blocks;
OA represents an alkylenoxy radical containing from 2 to 4 carbon atoms, on condition that all the radicals OA present in the compound of formula (1) are each independently of one another identical or different;
m1, m2, m3, m4, m5 and m6, which are identical or different, independently of one another each represent an integer between 1 and 20;
each radical R¹³, independently of one another, represents R¹ or a radical R¹²—(G)_{y}—, in which y is an integer from 0 to 5;
R¹⁰ represents R¹³ or R⁷;
R⁷ is chosen from:
a hydrocarbyl radical having 1 to 7 carbon atoms;
an aryl or arylalkyl radical;
a radical of formula H—(OA″)ᵥ— where v represents an integer from 1 to 20 and where OA″ represents an alkylenoxy group containing from 2 to 4 carbon atoms, HO(CH₂)_{q}—, where q represents an integer from 1 to 10; or
a radical of formula (2): 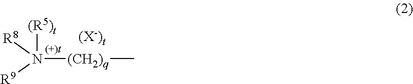
in which:
R⁵ is chosen from a C₁-C₆ hydrocarbyl radical, a C₁-C₄ alkyl, an aryl radical, or an arylalkyl radical;
X is chosen from halogens, sulfates, carbonates, or sulfonates;
t is 0 or 1, with the proviso that instances of t in formula (1), independently of one another may be identical or different; and either
R⁸ and R⁹, which are identical or different, are chosen from a hydrocarbyl radical having 1 to 6 carbon atoms, and q is an integer from 1 to 10; or
R⁸ and R⁹, together with the nitrogen atom to which they are attached, form a 5-, 6- or 7-membered ring, including optionally one or more heteroatoms chosen from oxygen, nitrogen or sulfur;
R¹² is chosen from a hydrocarbyl radical having 8 to 24 carbon atoms, or a radical of formula R⁴—O-(A′O)_{w}-T—, in which:
R⁴ is a hydrocarbyl radical having 8 to 24 carbon atoms;
A′O represents an alkylenoxy radical containing 2 to 4 carbon atoms;
w is an integer from 0 to 20; and
T represents an alkylene radical containing from 1 to 6 carbon atoms;
R¹ is chosen from a hydrocarbyl radical having from 8 to 24 carbon atoms, or a radical of formula R⁴—O-(A′O)_{w}-T—, in which:
R⁴ is a hydrocarbyl radical having 8 to 24 carbon atoms;
A′O represents an alkylenoxy radical containing 2 to 4 carbon atoms;
w is an integer from 0 to 20; and
T represents an alkylene radical containing from 1 to 6 carbon atoms; and
G represents a radical of formula (3): 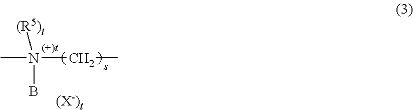
in which:
R⁵ is chosen from a C₁-C₆ hydrocarbyl radical, a C₁-C₄ alkyl, an aryl radical, or an arylalkyl radical;
X is chosen from halogens, sulfates, carbonates, or sulfonates;
t is 0 or 1, with the proviso that instances oft in formula (3), independently of one another may be identical or different;
B is chosen from C₁-C₄ alkyl, aryl radicals, or arylalkyl radicals; and
s represents 1, 2, or 3;
with the proviso that if there are two or more variables with the same name present in the compound of formula (1), they may be identical or different, independently of one another.

29. The compound of claim 28, in which at least one of (a), (b), and/or (c) are true:
(a) R_{A} and R_{B} are chosen from the group consisting of divalent hydrocarbyl radicals having from 1 to 10; and/or
(b) R⁷ is chosen from a hydrocarbyl radical having 1 to 4 carbon atoms; and/or
(c) OA represents an ethoxy radical.

30. The compound of claim 28, in which all instances oft are equal to 1.

31. The compound of claim 28, obtained from simultaneous or sequential or alternating esterification condensation reaction(s) of:
at least one compound of formula (I), in which y=0 and R¹ is chosen from a hydrocarbyl radical having 8 to 24 carbon atoms; and
at least one compound of formula (II); and
at least one compound of formula (III), in which R⁷ is a hydrocarbyl radical having 1 to 7 carbon atoms; and
at least one compound of formula (V),
and also the products of partial or complete quaternization reaction thereof.
